(19) United States
(12) Patent Application Publication
(10) Pub. No.: US 2016/0196098 A1
(43) Pub. Date: Jul. 7, 2016

(54) METHOD AND SYSTEM FOR CONTROLLING A HUMAN-MACHINE INTERFACE HAVING AT LEAST TWO DISPLAYS

(71) Applicant: Harman Becker Automotive Systems GmbH, Karlsbad (DE)

(72) Inventors: Hans Roth, Karlsruhe (DE); Christoph Reifenrath, Erftstadt (DE)

(21) Appl. No.: 14/983,327

(22) Filed: Dec. 29, 2015

(30) Foreign Application Priority Data
Jan. 2, 2015 (EP) 15150039.4

(51) Int. Cl. G06F 3/14; B60Q 9/00; B60K 35/00; G06F 3/01

(52) U.S. Cl. CPC G06F 3/1423; G06F 3/013; B60Q 9/00; B60K 35/00; B60K 2350/352

(57) ABSTRACT

A method and system for controlling a human machine interface disposed in a vehicle and having at least two displays, includes monitoring a gaze direction of a vehicle driver. Based on the monitoring, it is determined which of the at least two displays is closest to the gaze direction of the vehicle driver, and in response to the determining, a functionality of the closest of the at least two displays is automatically altered.

### CROSS REFERENCE TO RELATED APPLICATIONS

The present application claims priority to European Patent Application No. EP15150039.4, entitled “METHOD AND SYSTEM FOR CONTROLLING A HUMAN-MACHINE INTERFACE HAVING AT LEAST TWO DISPLAYS,” and filed on Jan. 2, 2015, the entire contents of which are hereby incorporated by reference for all purposes.

### TECHNICAL FIELD

The present disclosure relates generally to a display system in a vehicle. In particular, the disclosure is directed to an adaptive display system including at least two displays and a method for controlling a visual output of the at least two displays based on a gaze tracking of a vehicle driver.

### BACKGROUND

Eye-tracking devices detect the position and movement of an eye. Several varieties of eye-tracking devices are known. Currently, eye tracking devices and methods are implemented in vehicles to detect drowsiness and erratic behavior in a driver of a vehicle, as well as enable hands-free control of certain vehicle systems. However, drivers are frequently required to make use of display components (e.g. heads-up display, dashboard display, and center stack display) to obtain visual information about the vehicle environment in order to conduct a range of critical tasks (navigation, monitoring speed and fuel level, entertainment system control, etc.). The limited viewable area of each display and the distances between various displays generally requires too much of the driver's attention, particularly in critical driving situations.

It would be desirable to provide an adaptive display system wherein at least one display of a multiplicity of displays is automatically configured based upon a vision characteristic of a user to maximize a viewable area of a display component without the requirement of manual manipulation.

### SUMMARY

A method for controlling a human machine interface disposed in a vehicle and having at least two displays, includes monitoring a gaze direction of a vehicle driver. Based on the monitoring, it is determined which of the at least two displays is closest to the gaze direction of the vehicle driver, and in response to the determining, a functionality of the closest of the at least two displays is automatically altered.

A system for controlling a human machine interface disposed in a vehicle and having at least two displays, includes a gaze-tracking device operatively disposed in a vehicle and configured to monitor a gaze direction of a vehicle driver while the vehicle is in operation. The system further includes a processor operatively associated with the gaze-tracking device and the at least two displays, the processor being configured to, based on the monitoring, determine which of the at least two displays is closest to the gaze direction of the vehicle driver, and being configured to, in response to the determining, automatically alter a functionality of the closest of the at least two displays.

Other systems, methods, features and advantages will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The method and system may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 is a schematic diagram illustrating an example of a vehicle interior with three in-vehicle displays and a vehicle driver with his eyes focused beyond the displays;

FIG. 2 is a top view diagram depicting an example of a system for monitoring the gaze direction of a vehicle driver applicable in the interior shown in FIG. 1;

FIG. 3 is a lateral view diagram depicting an example of a system for monitoring the gaze direction of a vehicle driver applicable in the interior shown in FIG. 1;

FIG. 4 is a schematic diagram illustrating the closest display before and after a warning signal occurs;

FIG. 5 is a schematic diagram illustrating the closest display before and after exceeding a speed threshold;

FIG. 6 is a schematic diagram illustrating the closest display before and after exceeding a time threshold;

FIG. 7 is a block diagram illustrating a system or controlling a human machine interface having three displays;

FIG. 8 is a flow chart illustrating a method for controlling a human machine interface having three displays;

FIG. 9 shows an example in-vehicle computing system in accordance with one or more embodiments of the present disclosure.

### DETAILED DESCRIPTION

Examples of the method and system disclosed herein may employ monitoring a vehicle driver while he/she is operating a vehicle. This may be accomplished by utilizing a tracking device, which is operatively disposed inside the interior of the driver's vehicle. The tracking device determines an eye and/or facial position of the vehicle driver while he/she is driving. The eye and/or facial position is used to determine, for example, when the vehicle driver's eyes are, or face is focused on a particular object disposed inside the vehicle interior. If the driver's eyes are and/or face is found to be focusing on or close to an in-vehicle display, the functionality of that display may be automatically altered until the driver re-focuses his/her eyes/face back on the road.

As used herein, the term “vehicle driver” or “driver” refers to any person that is operating a mobile vehicle. It is to be understood that when the vehicle driver is “operating a vehicle”, the vehicle driver is controlling one or more operational functions of the vehicle. For example, the vehicle driver is considered to be “operating a vehicle” when the driver is physically steering the vehicle and/or controlling the gas and brake pedals while the transmission system is in a mode other than a park mode (e.g., a drive mode, a reverse mode, a neutral mode, etc.). Additionally, when the vehicle is “in operation”, the vehicle is powered on and one or more operational functions of the vehicle are being controlled by a vehicle driver.

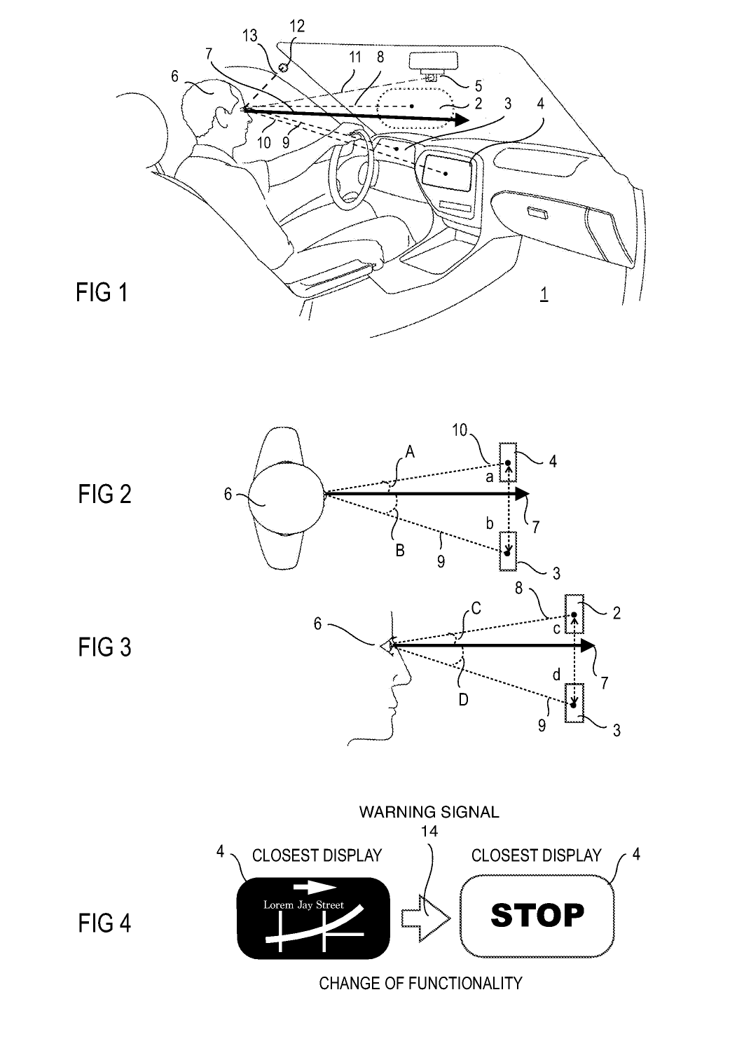

Examples of the method and system for controlling a human machine interface having at least two displays will now be described in conjunction with the figures. These examples are described herein below, when an exemplary vehicle 1 is in operation utilizing three displays 2-4 disposed inside the vehicle interior whose functionality may be altered, and a gaze-tracking device that may include an eye-tracking device and/or a face tracking device with a camera 5 and an optional additional camera 12 also disposed inside the vehicle interior. Vehicle 1 of FIG. 1 may be a motor vehicle including drive wheels and an internal combustion engine. Vehicle 1 may be a leading vehicle or a trailing vehicle of a fleet of vehicles. The internal combustion engine of vehicle 1 may include one or more combustion chambers which may receive intake air via an intake passage and exhaust combustion gases via an exhaust passage. Vehicle 1 may be a road automobile, among other types of vehicles. In some examples, vehicle 1 may include a hybrid propulsion system including an energy conversion device operable to absorb energy from vehicle motion and/or the engine and convert the absorbed energy to an energy form suitable for storage by an energy storage device. Vehicle 1 may include a fully electric vehicle, incorporating fuel cells, solar energy capturing elements, and/or other energy storage systems for powering the vehicle.

In these examples, camera 5 of the gaze-tracking device is attached to the rearview mirror, and camera 12 may be disposed in the left A-pillar of vehicle 1, as shown in FIG. 1. Instead of a camera any type of optical sensor or imaging system appropriate for tracking the eye or face may be used. The displays 2-4 may be part of any human-machine interface (HMI) disposed within the vehicle 1. Examples of the displays 2-4 include a Vacuum Fluorescent Display (VFD), a Light Emitting Diode (LED) display, a thin-film transistor (TFT) display, a driver information center display, a radio display, an arbitrary text device, a heads-up display (HUD), a Liquid Crystal Diode (LCD) display, and/or the like. In the example shown in FIG. 1, one display 2 is a heads-up display formed by a section of the windshield in front of a driver 6 onto which images are projected by a projector (not shown). Another display 3 is disposed in the dashboard in front of the driver 6, and still another display 4 is disposed in the center console. In the exemplary situation depicted in FIG. 1, the driver 6 looks through the windshield in a gaze direction 7 which does not intersect with any of the displays 2-4. The dotted line arrows 8-10 pointing from the driver's eyes to the displays 2-4 indicate the direction in which the driver's eyes are pointing during different situations, as described below. The portion of the dotted line arrows from the cameras 5 and 12 to the driver's eyes illustrates the respective line-of-sight between the cameras 5 and 12, respectively, and the driver's eyes. Gaze directions along lines 8-10 represent situations in which the driver 6 looks at one of the displays 2-4. The cameras 5 and 12 are each in line-of-sight 11 and 13, respectively, with the driver's eyes.

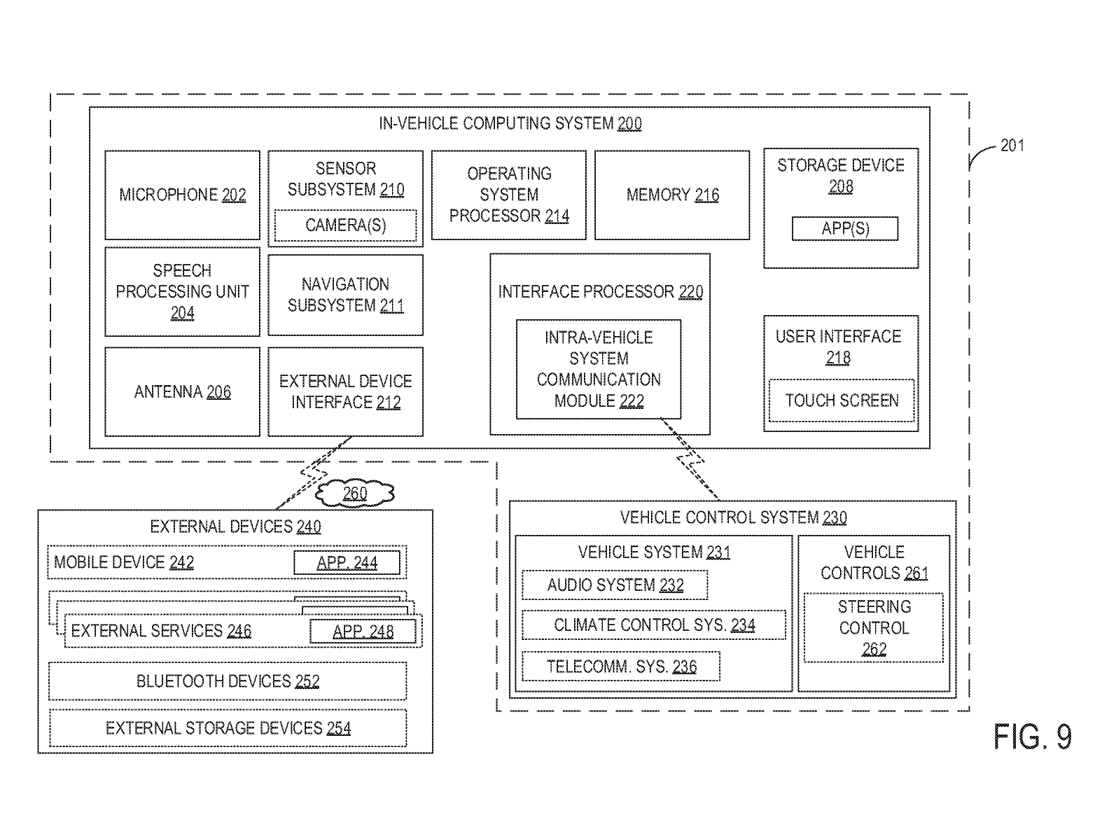

The displays 2-4 may, in some instances, be operated in connection with an audio component (not shown in FIG. 1), or may be independent of the audio component. The displays 2-4 may be in communication with a head unit (not shown in FIG. 1) that includes at least one internal processor such as, e.g., a micro-controller, a controller, a micro-processor, a signal processor or the like. For example, the head unit may include an in-vehicle computing system (e.g., an infotainment system), an example of which is illustrated in FIG. 9. In such an example, one of the displays 2-4 may include a touch screen of an in-vehicle computing system. In some embodiments, one or more hardware elements of an in-vehicle computing system, such as a touch screen, a display screen, various control dials, knobs and buttons, memory, processor(s), and any interface elements (e.g., connectors or ports) may form an integrated head unit that is installed in instrument panel of the vehicle. The head unit may be fixedly or removably attached in instrument panel. In additional or alternative embodiments, one or more hardware elements of the in-vehicle computing system may be modular and may be installed in multiple locations of the vehicle.

The at least one processor may include an application (e.g., computer program code encoded on a computer readable medium) for automatically altering the functionality of each of the displays 2-4 in response to receiving an indication from, for example, the gaze-tracking device that the vehicle driver's focus is directed roughly toward one of the displays 2-4. However, the wider area around and the location of the displays, windscreen and rear- and side mirrors may be also determined as target areas. In an example, the at least one processor initiates directly or dependent on further conditions the automatic altering of the functionality of the closest display as soon as a signal (to do so) is received from the gaze-tracking device.

In addition to the gaze-tracking device, the vehicle may include one or more sensors for monitoring the vehicle, the user, and/or the environment. For example, the vehicle may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin, etc. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as sensors coupled to external devices and/or a mobile device.

The cabin of vehicle 1 may also include one or more user objects, such as a mobile device, that are stored in the vehicle before, during, and/or after travelling. The mobile device may include a smart phone, a tablet, a laptop computer, a portable media player, and/or any suitable mobile computing device. The mobile device may be connected to the in-vehicle computing system via a communication link. The communication link may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct Near-Field Communication [NFC], cellular connectivity, etc.) and configured to provide two-way communication between the mobile device and the in-vehicle computing system. The mobile device may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link may provide sensor and/or control signals from various vehicle systems (such as vehicle audio system, climate control system, etc.) and the touch screen to the mobile device and may provide control and/or display signals from the mobile device to the in-vehicle systems and the touch screen. The communication link may also provide power to the mobile device from an in-vehicle power source in order to charge an internal battery of the mobile device.

The in-vehicle computing system may also be communicatively coupled to additional devices operated and/or accessed by the user but located external to vehicle 1, such as one or more external devices. In the depicted embodiment, external devices are located outside of vehicle 1 though it will be appreciated that in alternate embodiments, external devices may be located inside the cabin of the vehicle. The external devices may include a server computing system, personal computing system, portable electronic device, electronic wrist band, electronic head band, portable music player, electronic activity tracking device, pedometer, smart-watch, GPS system, etc. External devices may be connected to the in-vehicle computing system via a communication link, which may be wired or wireless, as discussed above, and configured to provide two-way communication between the external devices and the in-vehicle computing system. For example, external devices may include one or more sensors and a communication link may transmit sensor output from external devices to in-vehicle computing system and an associated touch screen. External devices may also store and/or receive information regarding contextual data, user behavior/preferences, operating rules, etc. and may transmit such information from the external devices to the in-vehicle computing system and touch screen.

The in-vehicle computing system may analyze the input received from external devices, a mobile device, and/or other input sources and select settings for various in-vehicle systems (such as climate control system or audio system), provide output via one or more of displays 2-4 and/or speakers in the vehicle, communicate with a mobile device and/or external devices, and/or perform other actions based on the assessment. In some embodiments, all or a portion of the assessment may be performed by the mobile device and/or the external devices. In some embodiments, the external devices may include in-vehicle computing devices of another vehicle, as such the vehicle may be a vehicle leading the vehicle 1, or may be a vehicle trailing behind vehicle 1.

In some embodiments, one or more of the external devices may be communicatively coupled to in-vehicle computing system indirectly, via a mobile device and/or another of the external devices. For example, a communication link may communicatively couple external devices to a mobile device such that output from external devices is relayed to the mobile device. Data received from external devices 150 may then be aggregated at the mobile device with data collected by the mobile device, the aggregated data then transmitted to in-vehicle computing system and associated display via a communication link. Similar data aggregation may occur at a server system and then transmitted to the in-vehicle computing system and associated display via a communication link.

As shown in FIGS. 2 and 3, the closest display may be detected by comparing the actual gaze-direction 7 with the gaze directions 8-10 that would apply if the driver 6 looks at one of the displays 2-4. Additionally or alternatively, the gaze tracking system may determine any other of the target area(s) the driver is looking at as a basis to alter the functionality of the closest display. The distance between the actual gaze direction 7 and the gaze directions 8-10 when looking at the displays 2-4 may be expressed as angle measures A-D, as parts a-d of the direct route from one display to another, by way of a two-dimensional or three-dimensional coordinate system (not shown), or any other appropriate way. Referring to FIG. 2, which is a top view of the situation shown in FIG. 1, the horizontal line between, e.g., displays 3 and 4 is cut into two parts a and b by gaze direction 7. As the distance between displays 3 and 4 is essentially constant and known, the parts a and b can be calculated. Alternatively, the parts A and B of the angle measure can be determined in that the angle measure between lines 9 and 10 representing the gaze directions from the driver 6 to the displays 3 and 4, which is essentially constant and known, is split in two parts A and B by actual gaze direction 7. Referring to FIG. 3, which is a lateral view of the situation shown in FIG. 1, the vertical line between, e.g., displays 2 and 3 is cut in two parts c and d by gaze direction 7. As the distance between displays 2 and 3 is essentially constant and known, the parts c and d can be calculated. Alternatively, the parts C and D of the angle measure can be determined in that the angle measure between lines 8 and 9 representing the gaze directions from the driver 6 to the displays 2 and 3, which is essentially constant and known, is split in two parts C and D by actual gaze direction 7. From parts A-D or a-d, respectively, the display closest to the actual gaze direction 7 can be identified using standard geometry.

Dependent on the detected gaze direction the functionality of the closest display (in contrast to the other displays) may be altered via multiple different mechanism as for example: i) In a first exemplary mechanism, all displays are switched off, deactivated or in a power saving mode at one time except the closest display which is active, switched on or in a power mode. The content displayed may be independent from the actual gaze direction, which means each display shows its usual content if selected as closest display. Alternatively, the content may be altered as in the mechanism described below. ii) In a second exemplary mechanism, all displays are active, but only the content displayed on the closest display is altered. For example, a summary of the most important driver information is displayed on the closest display instead of or additionally to its usual content (e.g., the content displayed before the gaze is determined to be closest to that display). iii) In a third exemplary mechanism, which may be used in connection with mechanisms i) and ii), the functionality is altered only in case of, and maybe according to, a detected specific or exceptional situation such as the occurrence of a warning signal, exceedance of a vehicle speed limit, or exceedance of a certain time limit (e.g., when an amount of time that the user's gaze is directed at the closest display and/or away from the road/a target exceeds a threshold).

The functionality of the closest display that may be altered includes the function that displays content on the display screen. For instance, how the content is displayed on the display screen may be altered. In one example, if a navigation route is displayed on the display screen when it is determined that the driver's eyes are or face is focused on the closest display, the processor may execute a program/application that blacks out the screen (so that the navigation route is not viewable at all) or simplifies the navigation route content (such as the navigational map) so that only pertinent information that is immediately required (such as, e.g., the next turn instruction) is illustrated at the time of altering. Other functions of the closest display that may be altered include the number of command button choices available to the vehicle driver (e.g., limiting the command options to those pertaining to the application then-currently being run on the display), the amount of text shown on the display per item displayed (e.g., the navigational map may be displayed in a simplified form such that only an impending maneuver is shown), the amount of pictures and/or graphics shown on the display (e.g., all pictures and/or graphics may be removed), the font size of the displayed text (e.g., all of the content would still be shown on the display, but pertinent and/or urgent information may be illustrated with an increased font size), and/or the contrast ratio between pertinent/urgent text and the background palette of the display (e.g., the background palette may be faded slightly so that the text stands out). Another functionality that may be altered includes the power consumption and the brightness of the closest display.

Referring to FIG. 4, the closest display, e.g., display 4, may display a navigation route in a so-called (low-power) night mode, in which the background of the image displayed is mainly dark and the text and graphics are bright, when a warning signal 14 such as a collision warning, a lane departure warning, a driver inattentiveness warning, or any other driver assistance message is issued. Then, the content of display 4 is altered to a short message, e.g., “STOP”, which is presented in a (high-power) day mode (dark letters on bright background). The font size of the displayed text is increased and no disturbing graphics are displayed. Although not shown, the color may be changed into red, for instance, to highlight the warning nature of the message. Referring to FIG. 5, the closest display, again display 4, may display the same navigation route in the same way as shown in FIG. 4, when a signal 15 is issued that indicates that the vehicle speed is higher than a given threshold. Then, the content of display 4 is altered to a simpler illustration, e.g., only an arrow instead of the more complex illustration that was displayed, and is presented in the day mode (dark graphics on bright background). The size of the displayed graphics is increased and no further disturbing graphic elements are displayed.

Furthermore, if the system determines that the driver is not looking at the target area on the lane or street or through the HUD, the warning parameters for collision warning or lane departure warning may be altered, so that the driver is informed earlier about a hazardous situation. If the lane detection sensor or other sensors, e.g. turn-signal switch, detect the beginning of a lane change, then the system may verify whether the driver's eyes are gazing into the area of the (side) rear-view mirror(s). If driver is not gazing at the (side) rear-view mirror(s) for a determined time, the system provides an audible and/or optical warning at the closest display to remind the driver to look into the mirror prior to changing a lane.

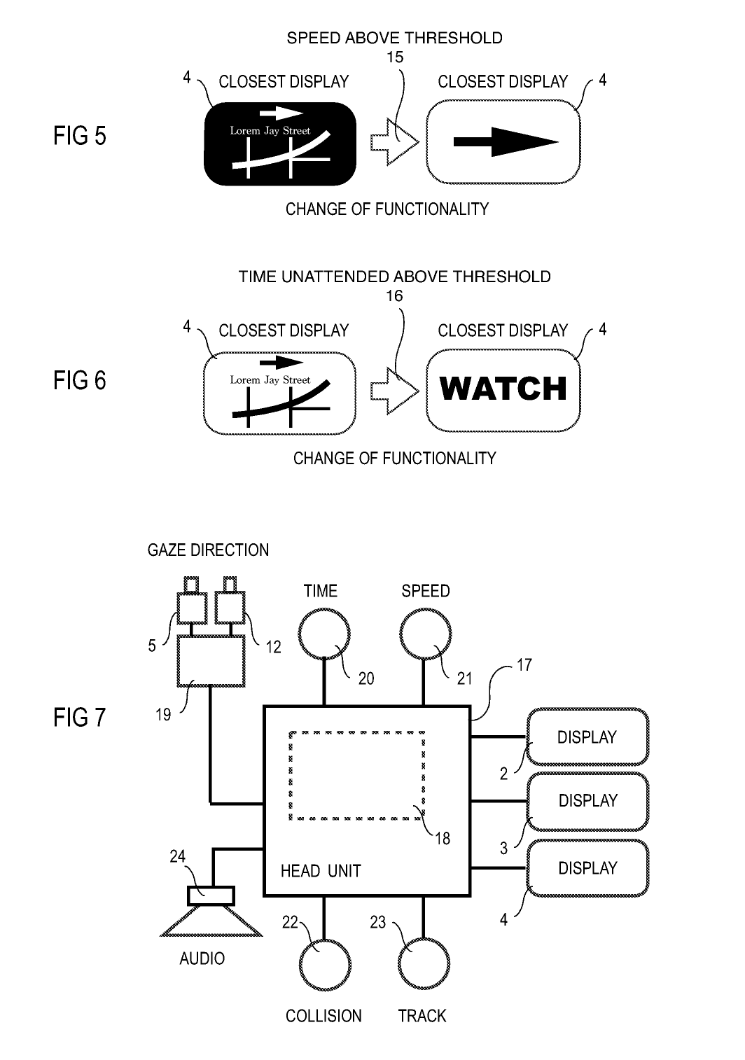

Referring to FIG. 6, the closest display, again display 4, may display the same navigation route as shown in FIG. 4 but now in day mode, when a signal 16 is issued that indicates that the driver is gazing at the display for a time period that extends beyond a given threshold. Then, the content of display 4 is altered to a shorter message, e.g., “WATCH”, which is presented in the day mode (dark letters on bright background). The font size of the displayed text is increased and no disturbing graphics are displayed. Although not shown, the color may be changed into red, for instance, to highlight the warning nature of the message.

A block diagram of a system for controlling the multiplicity of displays 2-4 dependent on the gaze direction of the driver 6 is shown in FIG. 7. A head unit 17 may include a processor 18 or an array of processors, also referred to as processor 18 in the following description. The processor 18 and, consequently, the head unit 17 are associated with the three displays 2-4 and gaze detector 19 that includes the cameras 5 and 12 shown in FIG. 1. The head unit 17 with processor 18 may be linked to a time keeper 20 (which may alternatively be integrated in the head unit 17) and to various sensors that may be present in the vehicle, such as a speed sensor 21, a collision sensor 22, an object recognition sensor, a blindspot sensor and/or a lane tracking sensor 23. Furthermore, the head unit 17 may include or be linked to an audio system that comprises at least one loudspeaker 24 for reproducing acoustic messages and warning sounds.

As previously mentioned, the vehicle 1 further includes the gaze detector 19 that is operatively disposed inside the vehicle interior. In an example, the gaze detector 19 may include an eye-tracking device that is configured to monitor an eye position of the vehicle driver while the vehicle 1 is in operation. For instance, the gaze detector 19 may be used to measure the driver's eye position (e.g., the point of gaze) and/or the movement of the driver's eyes (e.g., the motion of the eyes relative to the driver's head). This may be accomplished by utilizing a facial imaging camera 5 (and/or 12), which may be placed inside the vehicle interior in any position that is in front of (either directly or peripherally) the vehicle driver. Example positions for the facial imaging camera 5 include on the rearview mirror (as shown in FIG. 1), on the dashboard, on the mounting stem of the steering wheel, or the like. The camera 5 is configured to take images or videos of the vehicle driver's face while driving, and the gaze detector 19 is further configured to extract the driver's eye position from the images/videos. In another example, the movement of the driver's eyes is determined by light (such as infrared light) reflected from the cornea of the eye, which is sensed by a suitable electronic device (which can be part of the gaze detector 19) or an optical sensor (not shown in FIG. 1). The information pertaining to the eye motion may then be utilized (e.g., by processor 18, shown in FIG. 7, associated with the eye gaze detector 19, or an additional processor) to determine the rotation of the driver's eyes based on changes in the reflected light.

The processor 18 associated with the gaze detector 19 executes computer program code encoded on a computer readable medium which directs the gaze detector 19 to monitor the eye position of the vehicle driver while he/she is driving. Upon determining that the driver's eye position has changed, the gaze detector 19, via the processor 18, is configured to determine the direction in which the driver's eyes are now focused. If, for example, the vehicle driver's eye position is such that his/her eyes are focused on one of the displays 2-4, the gaze detector 19 is configured to send a signal to the head unit 17 indicating that the driver's eyes are focused on or in the direction of a particular one of the displays 2-4.

It is to be understood that the gaze detector 19 may continue to monitor the eye position of the driver's eyes so that the gaze detector 19 can also determine when the driver's eyes are focused/directed away from the display (for example, back on the road). When this occurs, the gaze detector 19 is further configured to send another signal to, for example, head unit 17 indicating that the driver's eyes are no longer focused on the closest display but rather are focused in a forward direction. In response to receiving this signal, the head unit 17 can initiate another signal for the closest display to resume its original (usual) functionality.

In another example, the gaze detector 19 may include a facial imaging device. This device also uses an imaging or video camera (such as the camera 5 or 12 shown in FIG. 1) to take images/videos of the driver's face while he/she is operating the vehicle 1. The processor 18 associated with the facial imaging device uses the images/videos to determine that the driver's current line-of-sight is based, at least in part, on the facial position of the driver. The facial position may be determined, for example, by detecting the angle at which the driver's head is positioned in vertical and horizontal directions.

Similar to the eye-tracking device described above, the facial imaging device also uses an associated processor (e.g., processor 18) that executes an application/computer readable code. The application commands the device to monitor the facial position of the vehicle driver while the vehicle is in operation. This information is ultimately used to trigger the altering of the functionality of the closest display, in a manner similar to that previously described when the gaze detector 19 used is an eye-tracking device. The vehicle 1 may be considered to be in operation after the driver physically enters the interior of the vehicle 1 and physically activates the vehicle ignition system and is able to control the speed of the vehicle 1 to increase speed.

As soon as the vehicle 1 is in operation and the vehicle 1 has reached a predefined minimum threshold speed, the gaze detector 19 is activated so that the head unit 17 can monitor the vehicle driver. Since an eye-tracking device is used in this example, the eye position of the driver is monitored. If the gaze detector 19 is a facial imaging camera, the facial position of the vehicle driver may be monitored instead or additionally. Activation of the gaze detector 19 may occur, for example, when the vehicle 1 exceeds any predefined, calibratable minimum speed, such as 3 km/h, 5 km/h, or the like. It is to be understood that any vehicle speed may be set as the minimal threshold speed for activating the gaze detector 19.

The gaze detector 19 may remain activated as long as the vehicle 1 is in operation and, in some instances, as long as the vehicle speed exceeds the predefined minimum threshold value. In instances where the vehicle is actually turned off (e.g., the ignition key is actually removed from the ignition slot), the gaze detector 19 will turn off as well. However, in instances where the vehicle 1 is stopped (e.g., at a traffic light), or is travelling at a speed below a predefined vehicle speed (i.e., the minimum threshold value mentioned above), or the transmission system is changed into a park mode, but the vehicle 1 has not been turned off, the gaze detector 19 may remain in the monitoring mode or may go into a sleep mode. The gaze detector 19 may remain in the sleep mode until i) the vehicle 1 starts moving and exceeds the predefined speed, or ii) the vehicle 1 is turned off. In some cases, if the vehicle 1 speed remains below the minimum threshold value for a predefined amount of time (e.g., 30 seconds, 1 minute, etc.), the gaze detector 19 may automatically shut off. In other instances, once the gaze detector 19 is activated, it may remain in an on state until the vehicle 1 is powered off.

Once the gaze detector 19 has been activated and as long as it remains activated (e.g., not in sleep mode), an eye position of the vehicle driver is continuously monitored via the gaze detector 19. The monitoring of the eye position of the vehicle driver includes determining the direction in which the vehicle driver's eyes are pointed while he/she is operating the vehicle 1. In one example, the monitoring is accomplished by taking a plurality of still images or a video of the vehicle driver's face using the imaging device (such as, e.g., the camera 5 or 12) associated with the gaze detector 19. It is noted that the camera 5 (or 12) may be directly attached to the gaze detector 19, or the camera 12 (or 5) may be remotely located from the gaze detector 19. In this latter instance, the camera 12 may be placed in a position inside the vehicle interior that is in front of the vehicle driver (e.g., in order to take images/video of the driver's face), and the gaze detector 19 may be located elsewhere, such as next to or part of the head unit 17. The cameras 5 and 12 may therefore be in operative communication with the gaze detector 19.

The processor 18 associated with the gaze detector 19 extracts the position of the driver's eyes from the images/videos taken by the camera 5 (and/or 12), and compares the extracted eye position with a previously determined eye position. The eye position may be extracted, for instance, by using contrast to locate the center of the pupil and then using infrared (IR) non-collimated light to create a corneal reflection. The vector between these two features may be used to compute a gaze intersection point with a surface after calibration for a particular person. This previously determined eye position is the direction that the vehicle driver's eyes would have to be pointed towards for the processor 18 to conclude that the vehicle driver's eyes are focused on an object (e.g., the closest display) disposed inside the vehicle interior.

In an example, the processor 18 of the gaze detector 19 determines that the eye position of the driver is directed toward the closest display by comparing the driver's current eye position to a range constructed around the center of the respective display. If the eye position falls within this range, the processor 18 concludes that the driver is in fact looking at this display. Upon making this conclusion, the gaze detector 19 monitors the amount of time that the driver's eye position is focused on the display. In instances where the amount of time exceeds a predefined threshold (e.g., 1.5 seconds, 2 seconds, etc.), in one example, the gaze detector 19 sends a signal to the head unit 17 indicating that the vehicle driver's eyes are focused on the display. In response to this signal, the head unit 14 sends a signal to this display to automatically alter its functionality.

The predefined amount of time that the driver's eye position is directed toward the display (also referred to herein as the glance time) may be established as a preset value based, at least in part, on standard driving conditions and/or environmental conditions. For instance, the predefined amount of time may be a default setting, which may be applied for any conditions that appear to be standard driving conditions (e.g., a single passenger is present in the vehicle 1) and/or environmental conditions (e.g., city travel with a nominal amount of traffic). This default setting may be adjusted based, at least in part, on the vehicle speed. Furthermore, the head unit 17 may determine whether or not the vehicle 1 is traveling at a speed exceeding a predefined higher speed threshold described above. If the higher speed threshold is exceeded, then the head unit 17 sends a signal to the closest display to automatically alter its functionality.

As previously mentioned, the head unit 17 initiates the altering of the functionality of the closest display. In an example, the functionality of the closest display that is altered is how the content is displayed on the display screen. In some instances, any content being shown on the display screen (such as, e.g., a navigation route, radio station and song information, etc.) automatically fades or blacks out, leaving behind a blank or black screen. In another example, the content being shown on the display screen is simplified so that the driver is presented only with pertinent and/or urgent content on the display screen.

Upon altering the content shown on the closest display (e.g., via fading out or simplifying the content), a message may appear on the display screen, where such message is directed to the vehicle driver, and relates to the task of driving. For instance, the message may be a textual message that appears on the blank/black screen (in instances where the content was faded out) or over the simplified content (which becomes a background when the content is simplified). The textual message may relate to the task of driving. In other instances, the message may be a pictorial message that appears on the blank/black screen or over the simplified content. The pictorial message may take the form of an icon, picture, symbol, or the like that relates to the task of driving. The message to the driver may also be a combination of a textual message and a pictorial message. After altering the displaying of the content on the display screen, a textual message and/or a pictorial message may be displayed on the screen.

In still another example, when the content shown on the closest display is altered, an audible message may be played to the vehicle driver via the in-vehicle audio system. This audible message may be a previously recorded message or an automated message that includes, in some form, driving related information. The audible message alone may be played to the vehicle driver upon altering the functionality of the closest display, or the audible message may be played in addition to displaying a textual and/or pictorial message on the display screen.

The audio component must be powered on so that the audible message can be played to the vehicle driver via the speaker 24. In instances where the audio component is powered on and other audible content (e.g., music, a literary work, etc.) is being played on the audio component, the content being played will fade out prior to playing the message to the vehicle driver. In some cases, the previously played content will fade back in as soon as the message is played, while in other cases the previously played content will not fade back in until the driver refocuses his/her eyes/face in a forward direction (e.g., back toward the road). In this example, the audible message may be repeatedly played to the driver until the driver refocuses his/her eyes/face away from the currently watched display.

After the functionality of the closest display has been altered (and possibly a message displayed and/or played to the driver), the eye position of the driver's eyes are further monitored by the gaze detector 19, at least until the processor 18 associated with the gaze detector 19 recognizes that the eye position is such that the driver's eyes are focused away from the previously watched display. An example of this is shown in FIG. 1, where the solid line arrow 7 pointed from the driver's eyes to the windshield indicates the direction in which the driver's eyes are pointing after focusing his/her eyes/face away from the object. Upon making this recognition, the gaze detector 19 sends another signal to the head unit 17, and the head unit 17 in turn sends another signal to the previously watched display with instruction for the display to change back to its original functionality. For instance, if the content shown on the display screen was faded out, upon determining that the driver's eyes are or face is away from the previously watched display, the content previously shown on the screen fades back in. Likewise, if the content was simplified, upon making the determination that the driver's focus is away from the display, a complete set of the content is re-displayed and/or is viewable by the vehicle driver. The content displayed on the screen after functionality has been restored may or may not be the same content that was displayed when the functionality was altered.

When the eye position of the vehicle driver is such that the driver's focus is away from all displays 2-4, the driver's focus may be anywhere except for toward the displays 2-4. The message displayed on the closest display screen and/or played over the audio component directs the driver's eyes or face to a position other than toward the display. In the examples provided herein, the message relates to the task of driving. Accordingly, in an example, the gaze detector 19 determines that the driver's eyes are away from all of the displays 2-4 when the driver's eye position is directed forward.

The changing of the altered functionality of the closest display back into its original functionality may be accomplished upon detecting, via the gaze detector 19, that the vehicle driver's eye position is focused away from the closest display. This may be accomplished immediately upon making the detection, or after the gaze detector 19 has determined that the driver's eye position has been focused away from the closest display for at least a predefined amount of time. In this latter example, the predefined amount of time that the driver's focus may be turned away from the display 80 to have its functionality changed back may be 1.5 seconds, 2 seconds, or any preset value. In one particular example, the functionality of the closest display is restored when the gaze detector 19 determines that the driver's eyes are focused back on the road. The amount of time that the driver's eye position is away from the closest display, as previously described in conjunction with determining the amount of time for which the driver's eyes are focused on the closest display, may also be determined, at least in part, from the vehicle speed.

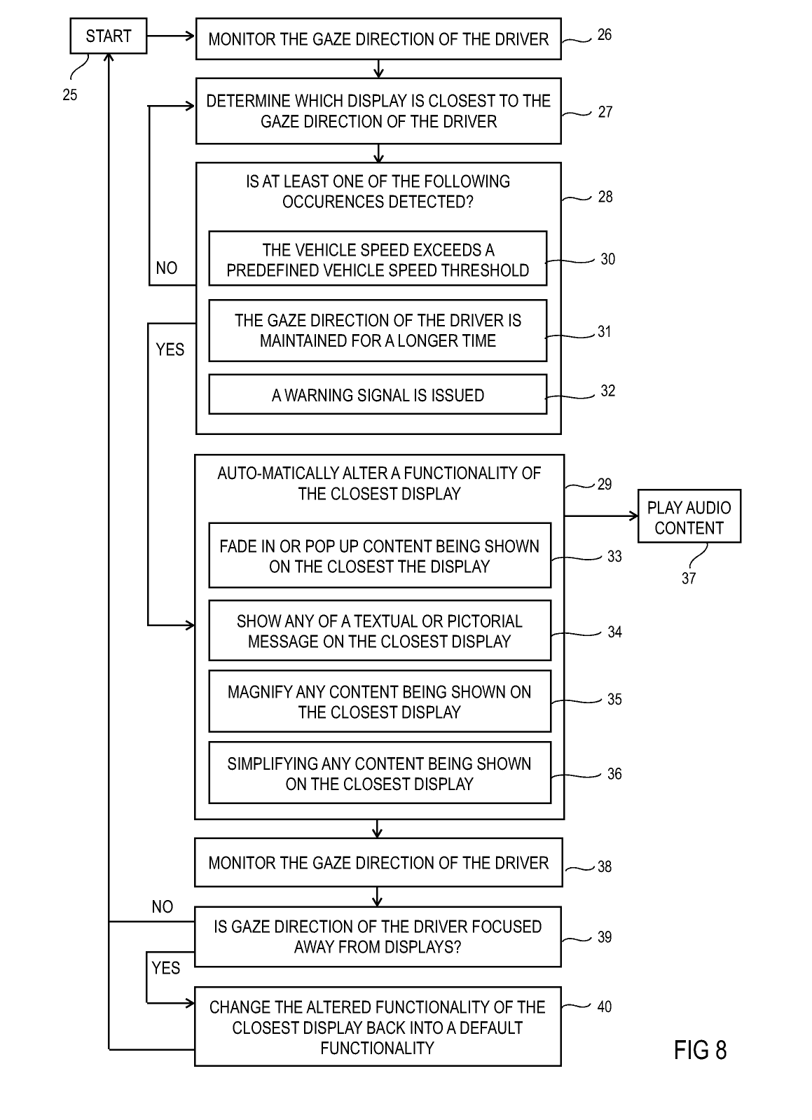

Referring to FIG. 8, an exemplary method for controlling a human machine interface disposed in a vehicle and having at least two displays includes, after conducting a starting routine as described above (procedure 25), monitoring the gaze direction of the vehicle driver (procedure 26). Based on the monitoring, it is determined which of the at least two displays is closest to the gaze direction of the vehicle driver (procedure 27) and, in response to the determining, a functionality of the closest of the at least two displays automatically is altered (procedure 28). In the present example, altering the functionality of the closest of the at least two displays is disabled (procedure 29) unless at least one of the following occurrences is detected: i) the vehicle speed exceeds a predefined (higher) vehicle speed threshold (sub-procedure 30), ii) the gaze direction of the vehicle driver is maintained for at least a predefined amount of time; (sub-procedure 31) and iii) a warning signal is issued by a driver assistant system or a vehicle control system (sub-procedure 32). The predefined amount of time may be based on the vehicle speed. Automatically altering the functionality of the closest of the at least two displays includes at least one of: i) fading in or popping up content being shown on the closest of the at least two displays (sub-procedure 33); ii) showing any of a textual or pictorial message on the closest of the at least two displays (sub-procedure 34); iii) magnifying any content being shown on the closest of the at least two displays (sub-procedure 35); and iv) simplifying any content being shown on the closest of the at least two displays (sub-procedure 36). Further an audible message through an audio system operatively disposed in the vehicle may be played (procedure 37), wherein the audible message may include an instruction for the vehicle driver. After automatically altering the functionality of the closest of the at least two displays, the gaze direction of the vehicle driver may be further monitored (procedure 38). Based on the further monitoring, that/whether the gaze direction of the vehicle driver is focused away from the at least two displays may be determined (procedure 39). In response to the determining that the gaze direction of the vehicle driver is focused away from the at least two displays, changing the altered functionality of the closest of the at least two displays back into a default functionality (procedure 40).

FIG. 9 shows a block diagram of an in-vehicle computing system 200 configured and/or integrated inside vehicle 201. In-vehicle computing system 200 may be an example of an in-vehicle computing system in vehicle 1 of FIG. 1 and/or may perform one or more of the methods described herein in some embodiments. In some examples, the in-vehicle computing system may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 201 in order to enhance an in-vehicle experience for a driver and/or a passenger.

In-vehicle computing system 200 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an intra-vehicle system communication module 222.

Intra-vehicle system communication module 222 may output data to other vehicle systems 231 and vehicle control elements 261, while also receiving data input from other vehicle components and systems 231, 261, e.g. by way of vehicle control system 230. When outputting data, intra-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network [CAN] bus through which engine related information may be communicated, a climate control CAN bus through which climate control related information may be communicated, and a multimedia data network through which multimedia data is communicated between multimedia components in the vehicle). For example, the in-vehicle computing system may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 200 to store data such as instructions executable by processors 214 and 220 in non-volatile form. The storage device 208 may store application data to enable the in-vehicle computing system 200 to run an application for connecting to a cloud-based server and/or collecting information for transmission to the cloud-based server. The application may retrieve information gathered by vehicle systems/sensors, input devices (e.g., user interface 218), devices in communication with the in-vehicle computing system (e.g., a mobile device connected via a Bluetooth link), etc. In-vehicle computing system 200 may further include a volatile memory 216. Volatile memory 216 may be random access memory (RAM). Non-transitory storage devices, such as non-volatile storage device 208 and/or volatile memory 216, may store instructions and/or code that, when executed by a processor (e.g., operating system processor 214 and/or interface processor 220), controls the in-vehicle computing system 200 to perform one or more of the actions described in the disclosure.

A microphone 202 may be included in the in-vehicle computing system 200 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 200 may also be able to receive voice commands and sample ambient vehicle noise using a microphone included in an audio system 232 of the vehicle.

One or more additional sensors may be included in a sensor subsystem 210 of the in-vehicle computing system 200. For example, the sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system 200 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 200 may generate and/or receive navigation information such as location information (e.g., via a GPS sensor and/or other sensors from sensor subsystem 210), route guidance, traffic information, point-of-interest (POI) identification, and/or provide other navigational services for the driver.

External device interface 212 of in-vehicle computing system 200 may be coupleable to and/or communicate with one or more external devices 240 located external to vehicle 201. While the external devices are illustrated as being located external to vehicle 201, it is to be understood that they may be temporarily housed in vehicle 201, such as when the user is operating the external devices while operating vehicle 201. In other words, the external devices 240 are not integral to vehicle 201. The external devices 240 may include a mobile device 242 (e.g., connected via a Bluetooth, NFC, WIFI direct, or other wireless connection) or an alternate Bluetooth-enabled device 252. Mobile device 242 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. External devices 240 may communicate with in-vehicle computing system 200 either wirelessly or via connectors without departing from the scope of this disclosure. For example, external devices 240 may communicate with in-vehicle computing system 200 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct, as described in more detail below.

One or more applications 244 may be operable on mobile device 242. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 242 from in-vehicle computing system 200 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, etc.) or other applications (e.g., navigational applications) of mobile device 242 to enable the requested data to be collected on the mobile device. Mobile device application 244 may then relay the collected information back to in-vehicle computing system 200.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers. Vehicle audio system 232 may be passive or active such as by including a power amplifier. In some examples, in-vehicle computing system 200 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 201. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 200, such as via communication module 222. The control elements of the vehicle control system may be physically and permanently positioned on and/or in the vehicle for receiving user input. In addition to receiving control instructions from in-vehicle computing system 200, vehicle control system 230 may also receive input from one or more external devices 240 operated by the user, such as from mobile device 242. This allows aspects of vehicle systems 231 and vehicle controls 261 to be controlled based on user input received from the external devices 240.

In-vehicle computing system 200 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via RF such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 240 (such as to mobile device 242) via external device interface 212.

One or more elements of the in-vehicle computing system 200 may be controlled by a user via user interface 218. User interface 218 may include a graphical user interface presented on a touch screen, such as touch screen 108 of FIG. 1, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 200 and mobile device 242 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

The systems and methods described above also provide for a method configured to control a human machine interface disposed in a vehicle and having at least two displays, the method comprising monitoring a gaze direction of a vehicle driver, based on the monitoring, determining which of the at least two displays is closest to the gaze direction of the vehicle driver, and in response to the determining, automatically altering a functionality of the closest of the at least two displays. In a first example of the method, the method may additionally or alternatively include the method wherein monitoring the gaze direction comprises determining at least one of an eye position or a facial position of the vehicle driver. A second example of the method optionally includes the first example of the method, and further includes the method wherein altering the functionality of the closest of the at least two displays is disabled unless at least one of the following occurrences is detected, the vehicle speed exceeds a predefined vehicle speed threshold, the gaze direction of the vehicle driver is maintained for at least a predefined amount of time, and a warning signal is issued by a driver assistant system or a vehicle control system. A third example of the method optionally includes one or both of the first and the second examples, and further includes the method wherein the predefined amount of time is based on the vehicle speed. A fourth example of the method optionally includes one or more of the first through the third examples, and further includes the method wherein automatically altering the functionality of the closest of the at least two displays includes at least one of fading in or popping up content being shown on the closest of the at least two displays, showing any of a textual or pictorial message on the closest of the at least two displays, magnifying any content being shown on the closest of the at least two displays, simplifying any content being shown on the closest of the at least two displays, and changing at least one of alert level, sensitivity timing and alert timing of a driver assistant system or a vehicle control system so that a reaction time increase for the driver is achieved. A fifth example of the method optionally includes one or more of the first through the fourth examples, and further includes the method further comprising playing an audible message through an audio system operatively disposed in the vehicle, the audible message including an instruction for the vehicle driver. A sixth example of the method optionally includes one or more of the first through the fifth examples, and further comprises after automatically altering the functionality of the closest of the at least two displays, further monitoring the gaze direction of the vehicle driver, based on the further monitoring, determining that the gaze direction of the vehicle driver is focused away from the closest of the at least two displays, and in response to the determining that the gaze direction of the vehicle driver is focused away from the at least two displays, changing the altered functionality of the at least two displays back into a default functionality. A seventh example of the method optionally includes one or more of the first through the sixth examples, and further comprises based on the monitoring, determining at least one of a time period during which the driver is not looking at the street or lane while driving and determining if the driver is looking into one of the rear-view mirrors.

The systems and methods described above also provide for a system configured to control a human machine interface disposed in a vehicle and having at least two displays, the system comprising a gaze-tracking device operatively disposed in the vehicle, the gaze-tracking device configured to monitor a gaze direction of a vehicle driver while the vehicle is in operation, and a processor operatively associated with the gaze-tracking device and the at least two displays, the processor configured to, based on the monitoring, determine which of the at least two displays is closest to the gaze direction of the vehicle driver, and configured to, in response to the determining, automatically alter a functionality of the closest of the at least two displays. A first example of the system further comprises the system wherein the gaze-tracking device is further configured to determine at least one of an eye position or a facial position of the vehicle driver to monitor the gaze direction. A second example of the system optionally includes the first example and further comprises the system wherein the processor is configured to evaluate at least one of a vehicle speed, a timer signal and a warning signal, wherein altering the functionality of the closest of the at least two displays is disabled unless at least one of the following occurrences is detected the vehicle speed exceeds a predefined vehicle speed threshold, the gaze direction of the vehicle driver is maintained for at least a predefined amount of time, and a warning signal is issued by a driver assistant system or a vehicle control system. A third example of the system optionally includes one or both of the first and the second examples, and further includes the system wherein the predefined amount of time is based on the vehicle speed. A fourth example of the system optionally includes one or more of the first through the third examples, and further includes the system wherein automatically altering the functionality of the closest of the at least two displays includes at least one of fading in or popping up content being shown on the closest of the at least two displays, showing any of a textual or pictorial message on the closest of the at least two displays, magnifying any content being shown on the closest of the at least two displays, and simplifying any content being shown on the closest of the at least two displays. A fifth example of the system optionally includes one or more of the first through the fourth examples, and further comprises an audio system operatively disposed in the vehicle and configured to play an audible message, the audible message including an instruction for the vehicle driver. A sixth example of the system optionally includes one or more of the first through the fifth examples, and further comprises the system wherein the processor is further configured to, after automatically altering the functionality of the closest of the at least two displays, further monitor the gaze direction of the vehicle driver, based on the further monitoring, determine that the gaze direction of the vehicle driver is focused away from the at least two displays, and in response to the determining that the gaze direction of the vehicle driver is focused away from the at least two displays, change the altered functionality of the closest of the at least two displays back into a default functionality.

The systems and methods described above also provide for a system configured to control a human machine interface disposed in a vehicle and having at least two displays, the system comprising a gaze-tracking device operatively disposed in the vehicle, the gaze-tracking device configured to monitor a gaze direction of a vehicle driver while the vehicle is in operation, a processor operatively associated with the gaze-tracking device and the at least two displays, and a storage device storing instructions executable by the processor to, based on the monitoring by the gaze-tracking device, determine a closest display of the at least two displays, the closest display being one of the at least two displays that is closest to the gaze direction of the vehicle driver, in response to the determining that the gaze direction is directed toward the closest display, monitoring an amount of time that the gaze direction is directed toward the closest display, and responsive to detecting that the amount of time that the gaze direction is directed toward the closest display exceeds a focus threshold, automatically alter a functionality of the closest display relative to a functionality of other displays of the at least two displays. A first example of the system includes the system wherein the focus threshold is based on a speed of the vehicle. A second example of the system optionally includes the first example, and further includes the system wherein determining that the gaze direction is directed toward the closest display comprises comparing the gaze direction to a range constructed around the center of the closest display, and determining that the gaze direction is directed toward the closest display responsive to determining that the gaze direction falls within the range. A third example of the system optionally includes one or both of the first and the second examples, and further includes the system wherein the instructions are further executable to monitor the gaze direction after altering the functionality of the closest display, and, responsive to determining that the gaze direction is no longer directed toward the closest display, automatically returning the closest display to an original functionality before the functionality was altered. A fourth example of the system optionally includes one or more of the first through the third examples, and further includes the system wherein automatically altering the functionality of the closest display relative to a functionality of other displays of the at least two displays includes switching off, deactivating, or placing each of the other displays of the at least two displays in a power save mode while maintaining the functionality of the closest display.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the in-vehicle computing system 109 described with reference to FIG. 1 and/or in-vehicle computing system 200 described with reference to FIG. 2, in combination with navigation system 300 described with reference to FIG. 3. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

While various embodiments of the invention have been described, it will be apparent to those of ordinary skill in the art that many more embodiments and implementations are possible within the scope of the invention.

1. A method configured to control a human machine interface disposed in a vehicle and having at least two displays, the method comprising:
monitoring a gaze direction of a vehicle driver;
based on the monitoring, determining which of the at least two displays is closest to the gaze direction of the vehicle driver; and
in response to the determining, automatically altering a functionality of the closest of the at least two displays.

2. The method of claim 1, wherein monitoring the gaze direction comprises determining at least one of an eye position or a facial position of the vehicle driver.

3. The method of claim 1, wherein altering the functionality of the closest of the at least two displays is disabled unless at least one of the following occurrences is detected:
the vehicle speed exceeds a predefined vehicle speed threshold;
the gaze direction of the vehicle driver is maintained for at least a predefined amount of time; and
a warning signal is issued by a driver assistant system or a vehicle control system.

4. The method of claim 3 wherein the predefined amount of time is based on the vehicle speed.

5. The method of claim 1, wherein automatically altering the functionality of the closest of the at least two displays includes at least one of:
fading in or popping up content being shown on the closest of the at least two displays;
showing any of a textual or pictorial message on the closest of the at least two displays;
magnifying any content being shown on the closest of the at least two displays;
simplifying any content being shown on the closest of the at least two displays; and
changing at least one of alert level, sensitivity timing and alert timing of a driver assistant system or a vehicle control system so that a reaction time increase for the driver is achieved.

6. The method of claim 1, further comprising playing an audible message through an audio system operatively disposed in the vehicle, the audible message including an instruction for the vehicle driver.

7. The method of claim 1, further comprising:
after automatically altering the functionality of the closest of the at least two displays, further monitoring the gaze direction of the vehicle driver;
based on the further monitoring, determining that the gaze direction of the vehicle driver is focused away from the closest of the at least two displays; and
in response to the determining that the gaze direction of the vehicle driver is focused away from the at least two displays, changing the altered functionality of the at least two displays back into a default functionality.

8. The method of claim 1, further comprising:
based on the monitoring, determining at least one of a time period during which the driver is not looking at the street or lane while driving and determining if the driver is looking into one of the rear-view mirrors.

9. A system configured to control a human machine interface disposed in a vehicle and having at least two displays, the system comprising:
a gaze-tracking device operatively disposed in the vehicle, the gaze-tracking device configured to monitor a gaze direction of a vehicle driver while the vehicle is in operation; and
a processor operatively associated with the gaze-tracking device and the at least two displays, the processor configured to, based on the monitoring, determine which of the at least two displays is closest to the gaze direction of the vehicle driver, and configured to, in response to the determining, automatically alter a functionality of the closest of the at least two displays.

10. The system of claim 9, wherein the gaze-tracking device is further configured to determine at least one of an eye position or a facial position of the vehicle driver to monitor the gaze direction.

11. The system of claim 9, wherein the processor is configured to evaluate at least one of a vehicle speed, a timer signal and a warning signal, wherein altering the functionality of the closest of the at least two displays is disabled unless at least one of the following occurrences is detected:
the vehicle speed exceeds a predefined vehicle speed threshold;
the gaze direction of the vehicle driver is maintained for at least a predefined amount of time; and
a warning signal is issued by a driver assistant system or a vehicle control system.

12. The system of claim 11, wherein the predefined amount of time is based on the vehicle speed.

13. The system of claim 9 wherein automatically altering the functionality of the closest of the at least two displays includes at least one of:
fading in or popping up content being shown on the closest of the at least two displays;
showing any of a textual or pictorial message on the closest of the at least two displays;
magnifying any content being shown on the closest of the at least two displays; and
simplifying any content being shown on the closest of the at least two displays.

14. The system of claim 9, further comprising an audio system operatively disposed in the vehicle and configured to play an audible message, the audible message including an instruction for the vehicle driver.

15. The system of claim 9, wherein the processor is further configured to:
after automatically altering the functionality of the closest of the at least two displays, further monitor the gaze direction of the vehicle driver;
based on the further monitoring, determine that the gaze direction of the vehicle driver is focused away from the at least two displays; and
in response to the determining that the gaze direction of the vehicle driver is focused away from the at least two displays, change the altered functionality of the closest of the at least two displays back into a default functionality.

16. A system configured to control a human machine interface disposed in a vehicle and having at least two displays, the system comprising:
a gaze-tracking device operatively disposed in the vehicle, the gaze-tracking device configured to monitor a gaze direction of a vehicle driver while the vehicle is in operation;
a processor operatively associated with the gaze-tracking device and the at least two displays; and
a storage device storing instructions executable by the processor to:
based on the monitoring by the gaze-tracking device, determine a closest display of the at least two displays, the closest display being one of the at least two displays that is closest to the gaze direction of the vehicle driver,
in response to the determining that the gaze direction is directed toward the closest display, monitoring an amount of time that the gaze direction is directed toward the closest display, and
responsive to detecting that the amount of time that the gaze direction is directed toward the closest display exceeds a focus threshold, automatically alter a functionality of the closest display relative to a functionality of other displays of the at least two displays.

17. The system of claim 16, wherein the focus threshold is based on a speed of the vehicle.

18. The system of claim 16, wherein determining that the gaze direction is directed toward the closest display comprises comparing the gaze direction to a range constructed around the center of the closest display, and determining that the gaze direction is directed toward the closest display responsive to determining that the gaze direction falls within the range.

19. The system of claim 16, wherein the instructions are further executable to monitor the gaze direction after altering the functionality of the closest display, and, responsive to determining that the gaze direction is no longer directed toward the closest display, automatically returning the closest display to an original functionality before the functionality was altered.

20. The system of claim 16, wherein automatically altering the functionality of the closest display relative to a functionality of other displays of the at least two displays includes switching off, deactivating, or placing each of the other displays of the at least two displays in a power save mode while maintaining the functionality of the closest display.
